(19) United States
(12) Patent Application Publication
(10) Pub. No.: US 2022/0194434 A1
(43) Pub. Date: Jun. 23, 2022

(54) APPARATUS FOR CONTROLLING AUTONOMOUS, SYSTEM HAVING THE SAME, AND METHOD THEREOF

(71) Applicants: HYUNDAI MOTOR COMPANY, Seoul (KR); Kia Corporation, Seoul (KR); HYUNDAI AUTOEVER Corp., Seoul (KR)

(72) Inventors: Chang Woo HA, Seoul (KR); Tae Sik KIM, Seoul (KR); Ho Jun KIM, Seoul (KR); Chang Eui SON, Seoul (KR); Eun Ho LEE, Seoul (KR); Jang Soon HAN, Seoul (KR)

(21) Appl. No.: 17/411,551

(22) Filed: Aug. 25, 2021

(30) Foreign Application Priority Data
Dec. 22, 2020 (KR) 10-2020-0181036

(51) Int. Cl. B60W 60/00; B60C 11/24; B60W 50/14; G06K 9/36; G06K 9/46

(52) U.S. Cl. CPC B60W 60/00186; G06K 2009/363; B60W 50/14; G06K 9/36; G06K 9/46; B60W 2530/20; B60W 2420/42; B60W 2510/207; B60W 2520/10; B60W 2520/12; B60W 2710/182; B60W 2720/10; B60W 2720/12; B60W 2552/35; B60W 2530/18; B60C 11/246

(57) ABSTRACT

An autonomous driving control apparatus may include a processor configured to determine a wear degree of a tire of a vehicle based on image data of the tire during autonomous driving of the vehicle, and to perform vehicle control depending on the wear degree of the tire; and a storage electrically connected to the processor and configured to store the image data and algorithms driven by the processor.

### CROSS-REFERENCE TO RELATED APPLICATION

The present application claims priority to Korean Patent Application No. 10-2020-0181036, filed on Dec. 22, 2020, the entire contents of which is incorporated herein for all purposes by this reference.

### BACKGROUND OF THE INVENTION

### Field of the Invention

The present invention relates to an autonomous driving control apparatus, a vehicle system including the same, and a method thereof, and more particularly, to a technique for diagnosing tire wear by use of a camera of the autonomous driving control device and applying it to autonomous driving vehicle control.

### Description of Related Art

Recently, a number of people interested in autonomous vehicles is increasing. A currently commercially available autonomous vehicle may apply advanced driver assistance systems (ADAS) not only to free a driver from simple tasks such as operating a steering wheel and pedals while driving, but also to prevent accidents in advance by reducing mistakes caused by driver's carelessness.

Such an autonomous vehicle may perform vehicle control based on a vehicle state. For example, the autonomous vehicle determines a vehicle control parameter based on a case in which a vehicle tire is in a normal state.

However, vehicle control variables need to be adjusted depending on wear of the vehicle tires and road surface conditions during actual driving.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing an autonomous driving control apparatus, a vehicle system including the same, and a method thereof, capable of determining a tire wear degree of a vehicle and applying it to autonomous driving control.

The technical objects of the present invention are not limited to the objects mentioned above, and other technical objects not mentioned may be clearly understood by those skilled in the art from the description of the claims.

Various aspects of the present invention are directed to providing an autonomous driving control apparatus including: a processor configured to determine a wear degree of a tire of a vehicle based on image data of the tire during autonomous driving of the vehicle, and to perform vehicle control depending on the wear degree of the tire; and a storage electrically connected to the processor and configured to store the image data and algorithms driven by the processor.

In various exemplary embodiments of the present invention, the processor may determine whether a steering angle is greater than a predetermined reference angle and a vehicle speed is smaller than a predetermined reference speed.

In various exemplary embodiments of the present invention, the processor may set the predetermined reference angle at a predetermined ratio of a maximum value of an angle sensor of a motor driving power steering (MDPS) system.

In various exemplary embodiments of the present invention, the processor may normalize the image data when the tire is not worn, to store the normalized image data in the storage as a reference image in advance.

In various exemplary embodiments of the present invention, the processor may store the image data of the tire captured for each surrounding environmental condition in the storage as a reference image when the tire is not worn.

In various exemplary embodiments of the present invention, the processor may correct lens distortion of the image data obtained by capturing an image of the tire.

In various exemplary embodiments of the present invention, the processor may extract a region of interest (ROI) from the image data, and may normalize the image data.

In various exemplary embodiments of the present invention, the processor may determine image complexity based on a difference between the reference image and a currently acquired image to determine the wear degree of the tire.

In various exemplary embodiments of the present invention, the processor may extract a plurality of ROIs from the image data depending on a position of the tire, and the plurality of ROIs includes an external ROI, a central ROI, and an internal ROI.

In various exemplary embodiments of the present invention, the processor may determine the wear degree for each of the ROIs.

In various exemplary embodiments of the present invention, the processor may determine a pneumatic pressure state of the tire by use of the wear degree of the central ROI of the tire and the wear degrees of the external ROI and the internal ROI of the tire.

In various exemplary embodiments of the present invention, the processor may determine that a tire pressure is excessive when a value obtained by subtracting half of a sum of the wear degrees of the external ROI and the internal ROI from the wear degree of the central ROI of the tire is greater than or equal to a predetermined first threshold, and determines that it is in a state where the tire pressure is insufficient when the obtained value is smaller than a predetermined second threshold.

In various exemplary embodiments of the present invention, the processor may determine a wheel balance of the tire by use of a difference between the wear degree of the external ROI of the tire and the wear degree of the internal ROI of the tire.

In various exemplary embodiments of the present invention, the processor may determine a risk state of the vehicle by determining a tire pressure state and a wheel balance of the vehicle according to the wear degree of the tire, and subdivides the risk state in stages.

In various exemplary embodiments of the present invention, the processor may perform a warning depending on the risk state, and may control a braking force or a vehicle speed of a vehicle depending on the wear degree of the tire.

In various exemplary embodiments of the present invention, the processor may determine the wear degree of front tires of the vehicle, estimates the wear degree of rear tires of the vehicle according to the wear degree of the front tires.

In various exemplary embodiments of the present invention, the processor may perform autonomous driving control depending on the wear degrees of the tires, a road surface condition, a driving score of a driver, and a driving distance of the vehicle.

Various aspects of the present invention are directed to providing a vehicle system including: a camera configured to photograph a tire of a vehicle during the vehicle's autonomous driving; and an autonomous driving control apparatus electrically connected to the camera and configured to determine a wear degree of a tire of a vehicle based on image data obtained by photographing the tire of the vehicle, and to perform vehicle control according to the wear degree of the tire.

Various aspects of the present invention are directed to providing an autonomous driving control method, including: photographing a tire of a vehicle during the vehicle's autonomous driving; determining a wear degree of the tire based on image data of the tire of the vehicle; and performing vehicle control according to the wear degree of the tire.

In various exemplary embodiments of the present invention, the determining of the wear degree of the tire may include determining the wear degree of the tire based on a comparison between a reference image obtained by photographing a tire which is not worn and an image obtained by photographing the worn tire.

According to the present technique, it is possible to increase safety of autonomous vehicles by determining the wear degree and applying it to autonomous driving control.

In addition, various effects that may be directly or indirectly identified through this document may be provided.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 illustrates a block diagram showing a configuration of a vehicle system including an autonomous driving control apparatus according to various exemplary embodiments of the present invention.

FIG. 2A, FIG. 2B and FIG. 2C illustrate views for describing a distortion correcting method of image data obtained by photographing a tire according to various exemplary embodiments of the present invention.

FIG. 3 illustrates a view for describing a tire wear diagnosis method according to various exemplary embodiments of the present invention.

FIG. 4A and FIG. 4B illustrate a histogram of a tire image according to various exemplary embodiments of the present invention.

FIG. 5 illustrates a view for describing a pneumatic pressure of a tire according to various exemplary embodiments of the present invention.

FIG. 6 illustrates a view for describing a wheel balance according to various exemplary embodiments of the present invention.

FIG. 7A and FIG. 7B illustrate views for describing a change in a braking length depending on tire wear on a high speed road and a vehicle road of an autonomous driving control apparatus according to various exemplary embodiments of the present invention.

FIG. 8 illustrates an autonomous driving control method depending on a tire wear diagnosis according to various exemplary embodiments of the present invention.

FIG. 9 illustrates a computing system according to various exemplary embodiments of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, some exemplary embodiments of the present invention will be described in detail with reference to exemplary drawings. It may be noted that in adding reference numerals to constituent elements of each drawing, the same constituent elements have the same reference numerals as possible even though they are indicated on different drawings. Furthermore, in describing exemplary embodiments of the present invention, when it is determined that detailed descriptions of related well-known configurations or functions interfere with understanding of the exemplary embodiments of the present invention, the detailed descriptions thereof will be omitted.

In describing constituent elements according to various exemplary embodiments of the present invention, terms such as first, second, A, B, (a), and (b) may be used. These terms are only for distinguishing the constituent elements from other constituent elements, and the nature, sequences, or orders of the constituent elements are not limited by the terms. In addition, all terms used herein including technical scientific terms have the same meanings as those which are generally understood by those skilled in the field of the invention to which various exemplary embodiments of the present invention pertains (those skilled in the art) unless they are differently defined. Terms defined in a generally used dictionary shall be construed to have meanings matching those in the context of a related art, and shall not be construed to have idealized or excessively formal meanings unless they are clearly defined in the present specification.

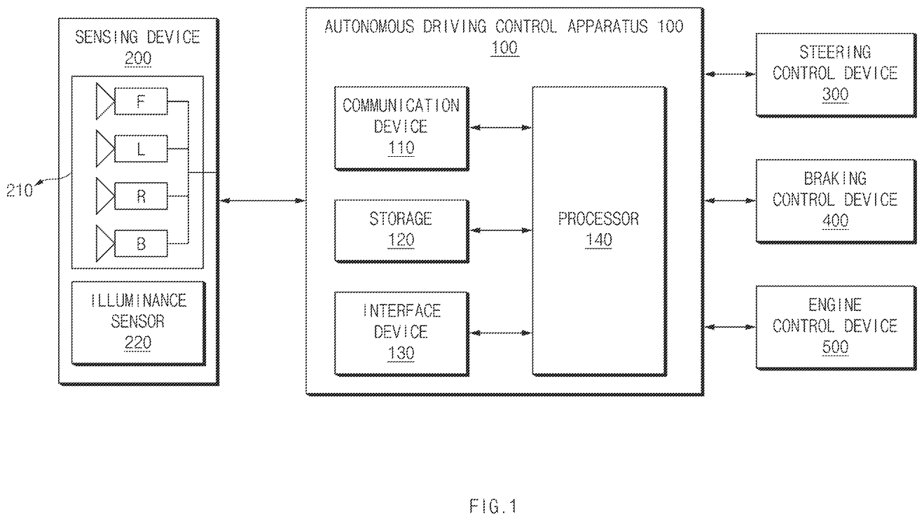

Hereinafter, various exemplary embodiments of the present invention will be described in detail with reference to FIG. 1 to FIG. 9.

FIG. 1 illustrates a block diagram showing a configuration of a vehicle system including an autonomous driving control apparatus according to various exemplary embodiments of the present invention.

Referring to FIG. 1, the vehicle system according to the exemplary embodiment of the present invention may include an autonomous driving control apparatus 100, a sensing device 200, a steering control device 300, a braking control device 400, and an engine control device 500.

The autonomous driving control apparatus 100 according to the exemplary embodiment of the present invention may be implemented inside the vehicle. In the instant case, the autonomous driving control apparatus 100 may be integrally formed with internal control units of the vehicle, or may be implemented as a separate device to be connected to control units of the vehicle by a separate connection means.

The autonomous driving control apparatus 100 may determine a wear degree of a tire of a vehicle based on image data of the tire during autonomous driving of the vehicle, and may perform vehicle control according to the wear degree of the tire. Furthermore, the autonomous driving control apparatus 100 may perform autonomous driving control in consideration of not only tire wear, but also road conditions (snow or rainy weather, pavement conditions, etc.), a driving distance, a driving score, and the like. That is, in the autonomous driving control apparatus 100, a lot of differences occur in a gripping force between a tire and a ground in the snow or rain condition, and thus when snow gets on wheels, snow may be detected through a camera, and changes in the gripping force between the tire and the ground of the autonomous vehicle may be reflected in the autonomous driving control. Furthermore, when a water film is formed due to a lot of rain, the autonomous driving control apparatus 100 may control the vehicle to perform a safer operation by braking it earlier than in a general environment by reflecting a control logic for the gripping force between the wheel and the ground.

Furthermore, the autonomous driving control apparatus 100 may also determine an objective risk level of tire wear by use of information related to a driving distance and a driving score depending on a driving habit of a driver together.

To the present end, the autonomous driving control apparatus 100 may include a communication device 110, a storage 120, and a processor 140.

The communication device 110 is a hardware device implemented with various electronic circuits to transmit and receive signals through a wireless or wired connection, and may transmit and receive information based on in-vehicle devices and in-vehicle network communication techniques. As an example, the in-vehicle network communication techniques may include controller area network (CAN) communication, local interconnect network (LIN) communication, flex-ray communication, and the like.

Furthermore, the communication device 110 may perform communication by use of a server, infrastructure, or third vehicles outside the vehicle, and the like through a wireless Internet access or short range communication technique. Herein, the wireless communication technique may include wireless LAN (WLAN), wireless broadband (Wibro), Wi-Fi, Worldwide Interoperability for Microwave Access (WiMAX), etc. Furthermore, short-range communication technique may include Bluetooth, ZigBee, ultra wideband (UWB), radio frequency identification (RFID), infrared data association (IrDA), and the like. As an example, the communication device 110 may communicate with the sensing device 200.

The storage 120 may store sensing results of the sensing device 200 and data and/or algorithms required for the processor 140 to operate, and the like.

As an example, the storage 120 may store image data of a camera which is received through the communication device 110.

The storage 120 may include a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and an optical disk.

The interface device 130 may include an input means for receiving a control command from a user and an output means for outputting an operation state of the apparatus 100 and results thereof. Herein, the input means may include a key button, and may include a mouse, a joystick, a jog shuttle, a stylus pen, and the like. Furthermore, the input means may include a soft key implemented on the display.

The interface device 130 may be implemented as a head-up display (HUD), a cluster, an audio video navigation (AVN), or a human machine interface (HM), a human machine interface (HMI).

The output device may include a display, and may also include a voice output means such as a speaker. In the instant case, when a touch sensor formed of a touch film, a touch sheet, or a touch pad is provided on the display, the display may operate as a touch screen, and may be implemented in a form in which an input device and an output device are integrated. As an example, the output device may output a tire pressure warning, a tire wear warning, and a wheel balancing warning. Furthermore, the output device may output driving information during autonomous driving control.

In the instant case, the display may include at least one of a liquid crystal display (LCD), a thin film transistor liquid crystal display (TFT LCD), an organic light emitting diode display (OLED display), a flexible display, a field emission display (FED), and a 3D display.

The processor 140 may be electrically connected to the communication device 110, the storage 120, the interface device 130, and the like, may electrically control each component, and may be an electrical circuit that executes software commands, performing various data processing and determinations described below.

The processor 140 may process signals transferred between constituent elements of the autonomous driving control apparatus 100. The processor 140 may be, e.g., an electronic control unit (ECU), a micro controller unit (MCU), or other subcontrollers mounted in the vehicle.

The processor 140 may determine a wear degree of a tire of a vehicle based on image data of the tire during autonomous driving of the vehicle, and may perform vehicle control according to the wear degree of the tire. Furthermore, the processor 140 may determine the wear degree of the tire in consideration of tire photographing image data, a driving distance and a driving score, a weather condition, and a road pavement condition.

The processor 140 may determine whether a steering angle is greater than a predetermined reference angle and a vehicle speed is smaller than a predetermined reference speed. In the instant case, the processor 140 may set the predetermined reference angle at a predetermined ratio of a maximum value of an angle sensor of a motor driving power steering (MDPS) system. That is, the processor 140 controls front tires of the vehicle to the left and right as much as possible through the steering control, so that the front of the tires may be photographed through a camera 210.

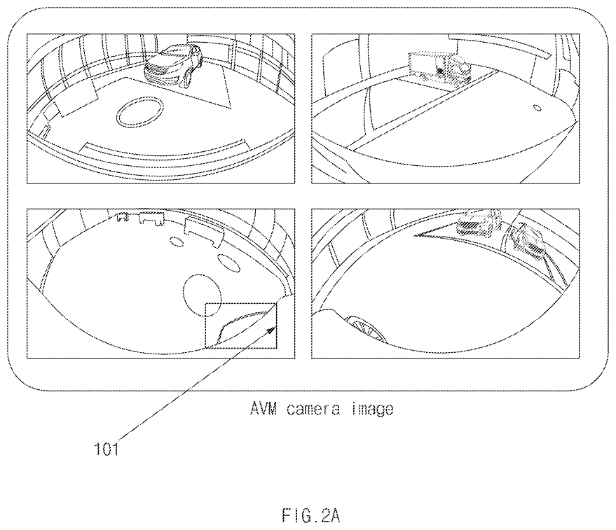

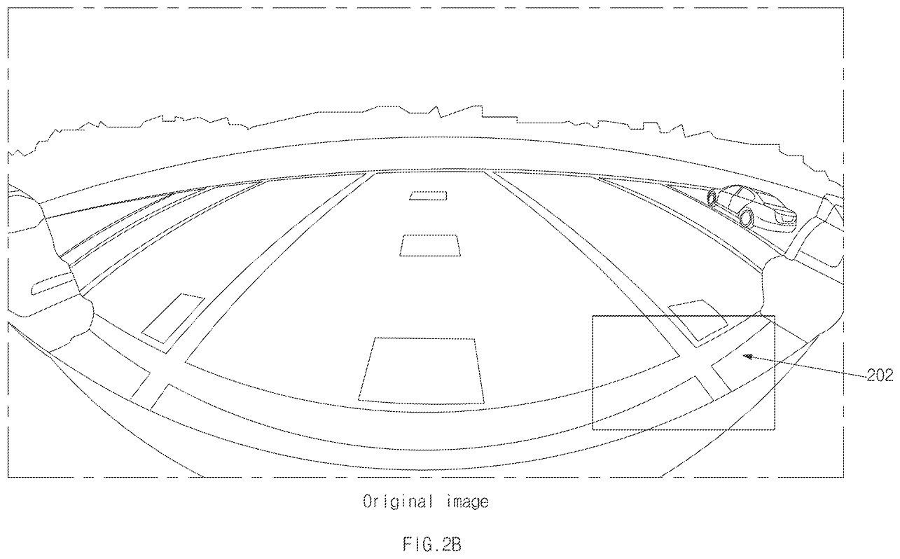

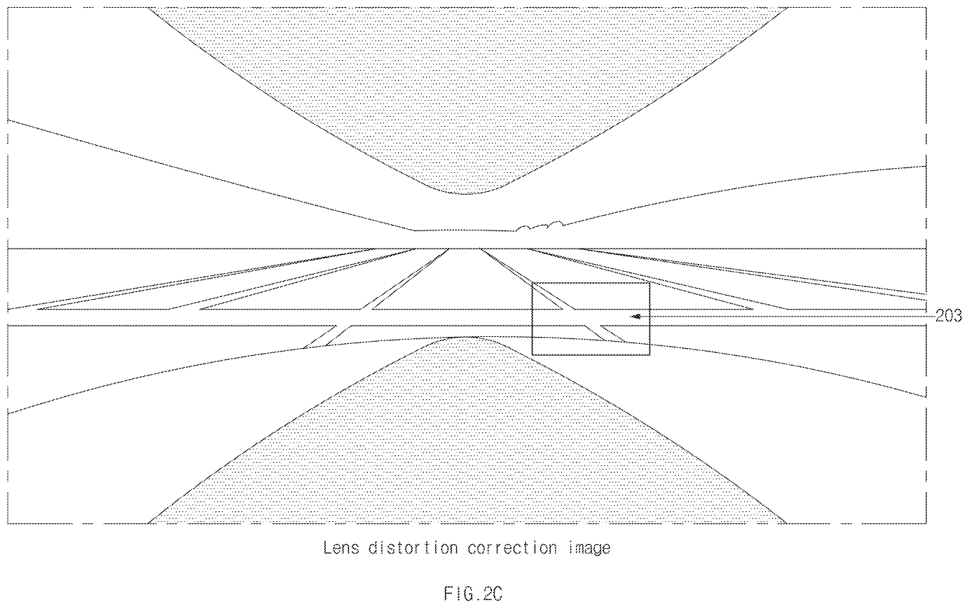

The processor 140 may correct lens distortion of image data obtained by photographing the tires. FIG. 2A to FIG. 2C illustrate views for describing a distortion correcting method of image data obtained by photographing a tire according to various exemplary embodiments of the present invention. The camera 210 is provided with a wide-angle lens having a wide field of view (FOV) so that a wide range may be viewed. However, severe distortion occurs as shown in FIG. 2A and FIG. 2B due to such a wide-angle lens. Such lens distortion mainly includes radial distortion in which a distortion degree of an image is determined by a distance from a center portion thereof, and tangential distortion that occurs when a camera lens and an image sensor (CCD or CMOS) are not leveled or caused by out of centering if a lens itself during camera manufacturing (assembly).

The processor 140 may perform lens distortion correction on a top-view image of FIG. 2B to determine the wear degree using the corrected image data as illustrated in FIG. 2C. For such distortion correction, the processor 140 may determine inverse coordinates to obtain a look-up table (LUT), and obtain a LUT of a specific portion of the tire to correct the distortion. Various algorithms configured for correcting lens distortion of a wide-angle lens may be used.

The processor 140 may normalize the image data when the tire is not worn to store it in the storage 120 as a reference image in advance.

When the tire is not worn, the processor 140 may store image data photographed for each surrounding environmental condition in the storage 120 as a reference image. In the instant case, the surrounding environmental conditions may include illumination, weather, and road pavement conditions.

The processor 140 may extract a region of interest from the image data, may normalize the image data, may determine image complexity based on a difference between a previously stored reference image and a currently acquired image, and may determine the wear degree.

The processor 140 may extract a plurality of regions of interest depending on a position of the tire, and the regions of interest may include an external region of interest, a central region of interest, and an internal region of interest. Accordingly, the processor 140 may determine the wear degree for each of the regions of interest.

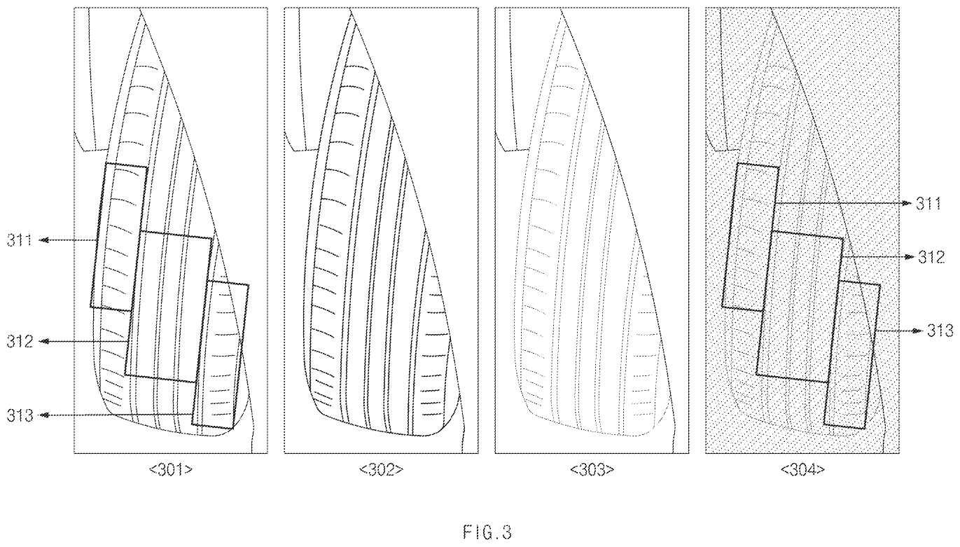

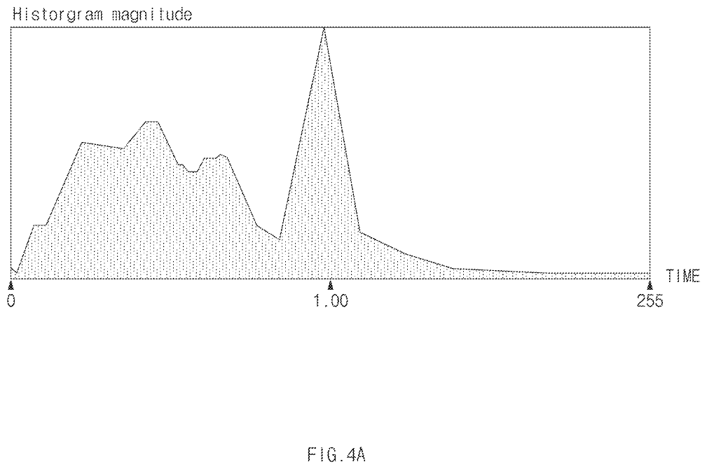

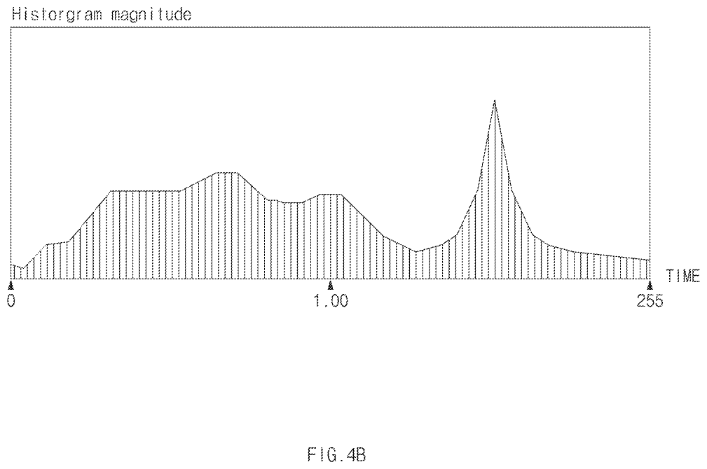

FIG. 3 illustrates a view for describing a tire wear diagnosis method according to various exemplary embodiments of the present invention, and FIG. 4A and FIG. 4B illustrate a histogram of a tire image according to various exemplary embodiments of the present invention.

An image 301 of FIG. 3 is original image data acquired from the camera 210, which is image data obtained by photographing a new tire that has not been worn, and is configured as a reference image. In the instant case, regions of interest (ROI) 311, 312, and 313 are set on tire image data. Herein, the ROIs are set as a tire external ROI 311, a center ROI 312, and an internal ROI 313, and may be set in advance by experimental values. For example, a predetermined length from an outermost to an internal side of the tire may be set as the external ROI 311.

An image 302 is a reference image obtained by normalizing the original image data of the image 301. That is, the image data needs to be normalized because quality of the image may vary depending on an environment (brightness). FIG. 4A illustrates a histogram which is a statistical value of brightness of the original image 301 of FIG. 3, and FIG. 4B illustrates a histogram of the image 302 of FIG. 3. The processor 140 may acquire an image having a normalized quality such as the image 302 by use of a method such as histogram smoothing.

An image 303 is normalized image data of a worn tire which is currently acquired, and an image 304 is a difference image between the reference image 302 and the acquired image 303. That is, the processor 140 may extract the ROI from the normalized image, and may determine mean absolute differences (MAD, image complexity) of the normalized reference image 302 and the currently acquired normalized image 303 by Equation 1 below.

$$MADi = \frac{1}{MN} {\sum }_{x = 0}^{M - 1} {\sum }_{y = 0}^{N - 1} \vert {f}_{i} ( x , y ) - {f}_{i}^{′} ( x , y ) \vert \\ i = 1 , 2 , 3 \\ t = \{ \begin{matrix}Abnormal Tire , & {MAD}_{t} \geq {th}_{1} \\ Normal Tire , & {MAD}_{t} < {th}_{1}\end{matrix} \qquad ( Equation 1 )$$

M and N denote pixel values of image magnitude. Histogram values of X from 0 to M−1 and Y from 0 to N−1 are extracted, and a value obtained by summing them is converted into an average value to output a result value.

A difference between the reference image and a current worn tire image is visually as shown in the image 304 of FIG. 3. The tire includes three regions to measure the wear degree to consider uneven wear.

That is, overall wear of the tire is also important, but a risk of accidents due to uneven wear is greater, and thus as illustrated in FIG. 3, the processor 140 may divide the tire into three regions of interest, i.e., an external region of interest 311, a central region of interest 312, and an internal region of interest 313 to measure the wear degree for each region to measure an uneven wear characteristics of a tire

In Equation 1, fᵢ(x,y) denotes the normalized pixel value Y of the currently acquired image, and f′ᵢ(x,y) denotes a normalized pixel value detected in the reference image. Furthermore, MAD1 indicates a wear degree of an external side of the tire, MAD2 indicates a wear degree of a center portion of the tire, and MAD3 indicates a wear degree of an internal side of the tire. Herein, MADt indicates an average value of MAD1, MAD2, and MAD3. The processor 140 may determine that the tire wear has significantly progressed when the MADt is greater than a threshold value th₁, and may determine that the tire is in a normal state where wear has not progressed when the MADt is not greater than the threshold value th₁.

Accordingly, the processor 140 may determine that the tire wear is higher as the MAD of Equation 1 increases.

The processor 140 may determine a pneumatic pressure state of the tire by use of the wear degree of the central region of interest of the tire and the wear degrees of the external ROI and the internal ROI of the tire.

The processor 140 may determine that a tire pressure is excessive when a value obtained by subtracting half of a sum of the wear degrees of the external ROI and the internal ROI from the wear degree of the central ROI of the tire is greater than or equal to a predetermined first threshold (e.g., positive number), and may determine that it is in a state where the tire pressure is insufficient when the obtained value is smaller than a predetermined second threshold (e.g., a negative number).

The processor 140 may determine a pneumatic pressure state by measuring a difference between relative uneven wear degrees of the center portion and the side of the tire. To the present end, the processor 140 may use Equation 2.

$$f = MA {D}_{2} - \frac{( {MAD}_{1} + {MAD}_{3} )}{2} \\ p = \{ \begin{matrix}Over Tire Pressure , & f \geq {th}_{2} \\ Under Tire Pressure , & f < {th}_{3}\end{matrix} \qquad ( Equation 2 )$$

For example, in Equation 2, when f is greater than a threshold value the (a positive number), it may be determined that it is in an excessive tire pressure state of the tire, while when f is smaller than a threshold value th₃ (a negative number), it may be determined that it is in an insufficient tire pressure of the tire.

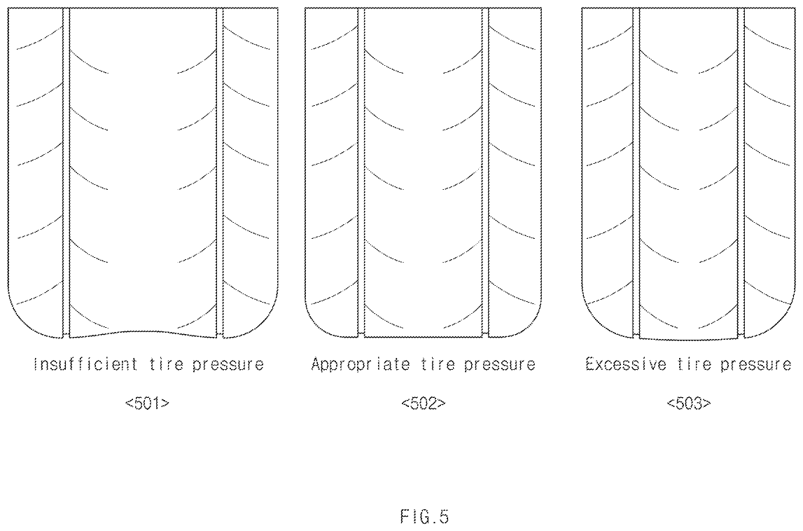

FIG. 5 illustrates a view for describing a pneumatic pressure of a tire according to various exemplary embodiments of the present invention. In FIG. 5, an image 501 denotes a state in which the tire pressure is insufficient, an image 502 denotes an appropriate tire pressure, and an image 503 denotes an excessive tire pressure.

The processor 140 may determine a wheel balance of the tire by use of a difference between the wear degree of the external ROI and the wear degree of the internal ROI.

As shown in Equation 3, the processor 140 may determine whether the wheel is balanced based on a difference between the wear degrees of the external side and the internal side of the tire.

$$g = \vert {MAD}_{1} - {MAD}_{3} \vert \\ w = \{ \begin{matrix}Abnormal Wheel , & g \geq {th}_{4} \\ Normal Wheel , & g < {th}_{4}\end{matrix} \qquad ( Equation 3 )$$

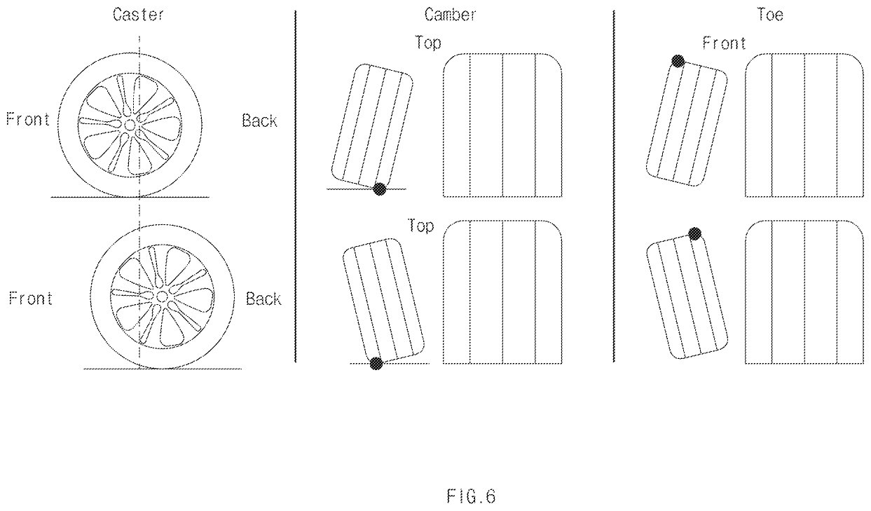

That is, as shown in Equation 3, the processor 140 may determine that the wheel balance is not in a normal state when a difference value g between the wear degrees of the external side and the internal side of the tire is greater than or equal to a threshold value th₄, and may determine that the wheel balance is in the normal state, otherwise. FIG. 6 illustrates a view for describing a wheel balance according to various exemplary embodiments of the present invention. As shown in FIG. 6, it may be seen that when uneven wear occurs on one side of the tire, the wheel balance is not in the normal state.

The processor 140 may determine a risk state by determining a tire pressure state and a wheel balance of the vehicle depending on a tire wear level, and may subdivide the risk state in stages. For example, the risk stage may be subdivided into caution, warning, and danger levels. The processor 140 may subdivide the risk state by stage depending on a magnitude of the image complexity.

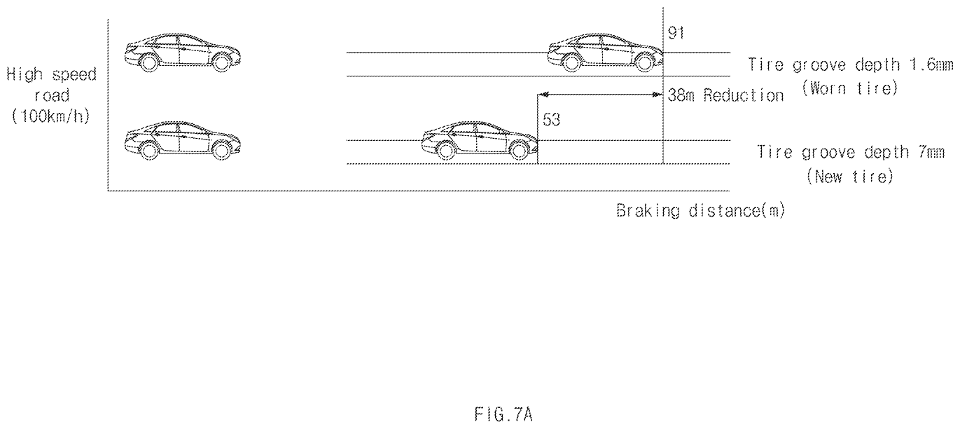

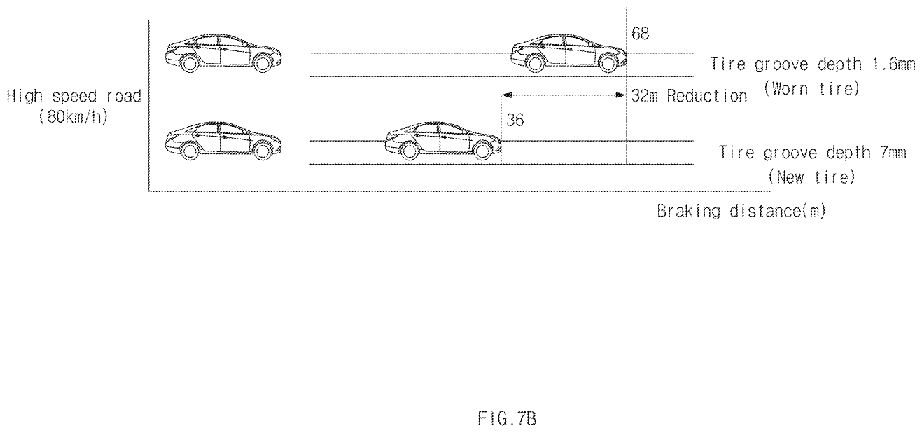

The processor 140 may perform a warning depending on the risk state and may control a braking force or a vehicle speed of the vehicle depending on the wear degree of the tire. FIG. 7A and FIG. 7B illustrate views for describing a change in a braking length depending on tire wear on a high speed road and a vehicle road of an autonomous driving control apparatus according to various exemplary embodiments of the present invention.

Referring to FIG. 7A, it may be seen that a braking distance is increased depending on the wear degree of the tire of the vehicle on the high speed road, and referring to FIG. 7B, it may be seen that the braking distance is increased depending on the wear degree of the tires on the vehicle road.

Accordingly, the processor 140 may control the braking force and the vehicle speed in consideration of an increase in the braking distance depending on the wear degree of the tire. That is, the processor 140 may increase the braking force or decrease the vehicle speed in advance when the wear degree of the tire increases.

The processor 140 may determine the wear degree of front tires of the vehicle, may estimate the wear degree of rear tires by use of the wear degree of the front tires of the vehicle, and may perform autonomous driving control depending on the wear degrees of the tires, a road surface condition, a driving score of a driver, and a driving distance of the vehicle.

The sensing device 200 may include one or more sensors that detect an obstacle, e.g., a preceding vehicle, positioned around the host vehicle and measure a distance with the obstacle and/or a relative speed thereof.

The sensing device 200 may include the camera 210 for photographing vehicle tires and an illuminance sensor 220. The camera 210 may be a camera mounted in a surround view monitoring (SVM) system. The camera 210 is mounted at each of front, opposite sides, and rear of the vehicle, and in various exemplary embodiments of the present invention, images of the front tires (right and left) may be acquired through the cameras mounted at the opposite sides.

The steering control device 500 may be configured to control a steering angle of a vehicle, and may include a steering wheel, an actuator interlocked with the steering wheel, and a controller configured for controlling the actuator.

The braking control device 600 may be configured to control braking of the vehicle, and may include a controller that is configured to control a brake thereof.

The engine control device 700 may be configured to control engine driving of a vehicle, and may include a controller that is configured to control a speed of the vehicle.

As described above, the present invention may determine a risk level of tire wear, may control a braking pressure, a vehicle speed, etc. In consideration of the braking distance depending on the tire wear level, and may inform a user of his to enable safe autonomous driving control.

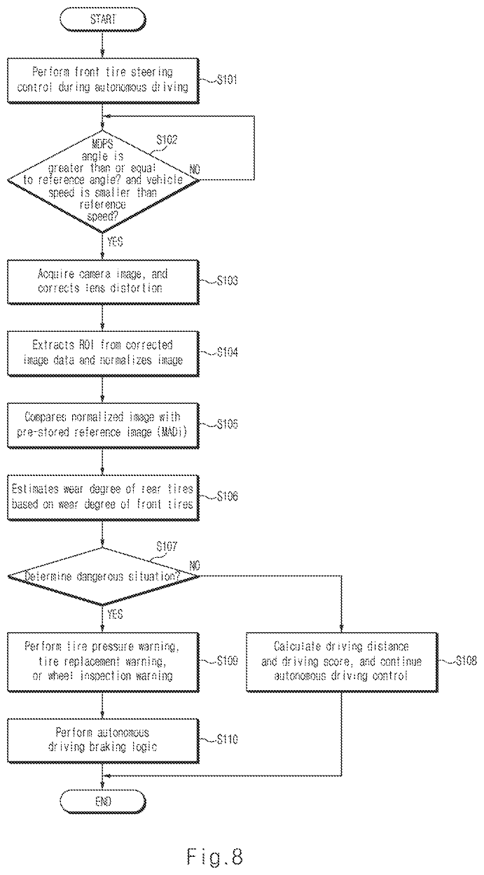

Hereinafter, an autonomous driving control method according to various exemplary embodiments of the present invention will be described in detail with reference to FIG. 8. FIG. 8 illustrates an autonomous driving control method depending on a tire wear diagnosis according to various exemplary embodiments of the present invention.

Hereinafter, it is assumed that the autonomous driving control apparatus 100 of the of FIG. 1 performs processes of FIG. 8. Furthermore, in the description of FIG. 8, operations referred to as being performed by a device may be understood as being controlled by the processor 140 of the autonomous driving control apparatus 100 of the.

Referring to FIG. 8, the autonomous driving control apparatus 100 performs front tire steering control during autonomous driving (S101).

The autonomous driving control apparatus 100 determines whether a steering angle is greater than or equal to a predetermined reference angle and a vehicle speed is smaller than a predetermined reference speed (S102). As illustrated in FIG. 3, it is determined whether tires are in a steered state so that the tires are clearly visible.

In the instant case, the reference angle may be predetermined to 25° as 80% of a maximum value of an MDPS angle sensor, and the wheel angle is about 90° as an angle at which the tires may be seen best and may be determined in advance by experimental values. Accordingly, it is necessary to acquire an image of at least 4 frames to photograph all side (circumference, 360°). Furthermore, when the vehicle speed is smaller than the predetermined reference speed, the autonomous driving control apparatus 100 may guarantee quality of image data, so that the reference speed may be predetermined, for example, the reference speed may be set to 10 km/h.

When the steering angle is greater than or equal to the predetermined reference angle and the vehicle speed is smaller than the predetermined reference speed, the autonomous driving control apparatus 100 acquires image data by photographing the front tires using the camera, and corrects lens distortion of the acquired image data. (S103). That is, the autonomous driving control apparatus 100 corrects distortions 101 and 201 of a wide-angle lens as illustrated in FIG. 2A and FIG. 2B.

The autonomous driving control apparatus 100 extracts ROIs from the corrected image data and normalizes the image (S104). In the instant case, the ROIs may be divided into an outer, a center, and an internal side of the tire, and may be predetermined.

Furthermore, since the autonomous driving control apparatus 100 needs to compare images under a same brightness condition when comparing the images, the images may be normalized.

The autonomous driving control apparatus 100 compares the normalized images with a pre-stored reference image (S105). In the instant case, the reference image includes a state in which an image captured when a new tire is replaced is normalized. The autonomous driving control apparatus 100 compares brightnesses of the ROI of the image normalized in step S104 with the ROI of the reference image.

That is, the reference image may be acquired and stored depending on various environmental conditions for a predetermined time period when a new tire is replaced. The autonomous driving control apparatus 100 may measure the wear degree of the tire by comparing the currently acquired image with a reference image of similar environmental conditions.

Furthermore, although a feature of determining the wear degree based on tire image data is disclosed, the wear degree is changed depending on driver's driving habits and a driving distance, and thus the autonomous driving control apparatus 100 may accurately determine the wear degree in consideration of not only the tire image data but also the vehicle driving distance and a driver driving score.

The autonomous driving control apparatus 100 determines the wear degree of the front tires based on a comparison result of step S105, and estimates the wear degree of the rear tires of the vehicle according to the wear degree of the front tires (S106). In the instant case, the autonomous driving control apparatus 100 may estimate the wear degree of the rear tires to be the same level as the wear degree of the front tires.

The autonomous driving control apparatus 100 determines a dangerous situation based on the wear degree of the front tires (S107). For example, a condition for determining the dangerous situation may include a tire pressure, a change in a braking distance depending on tire wear, wheel balancing, and the like.

When it is not in the dangerous situation, the autonomous driving control apparatus 100 may determine a driving distance and a driving score, and may continue autonomous driving control (S108).

When it is in the dangerous situation, the autonomous driving control apparatus 100 may perform a tire pressure warning, a tire replacement warning, a wheel inspection warning, etc. (S109), and may perform an autonomous driving braking logic depending on a tire condition (S110).

In the instant case, the autonomous driving control apparatus 100 may determine a risk level (attention, warning, danger, etc.) depending on the tire condition by classifying it. The autonomous driving control apparatus 100 notifies the driver and surrounding vehicles of it and simultaneously reflects it on the braking logic of the autonomous driving vehicle depending on the risk level to secure a braking distance, facilitating safe driving. As illustrated in FIG. 7A and FIG. 7B, since the braking distance increases depending on tire wear, a vehicle speed and a braking force may be controlled in consideration of the braking distance depending on the tire wear.

Furthermore, the autonomous driving control apparatus 100 may make risk determination in consideration of weather conditions such as snow and rainy weather and road conditions (paved, unpaved, etc.), and may control the vehicle speed and the braking force (brake hydraulic pressure, etc.) of the vehicle in consideration of not only tire wear, but also weather conditions, road pavement conditions, etc. In the instant case, weather conditions such as snow and rain may be checked through image data photographing snow or rain on the tire or through a separate rain sensor. A pavement state of the road may be obtained from map information received from a navigation system or the like.

Furthermore, when the risk level is the warning level or a higher level, the autonomous driving control apparatus 100 may perform driving control such that the autonomous driving vehicle may visit a repair shop for tire replacement by itself.

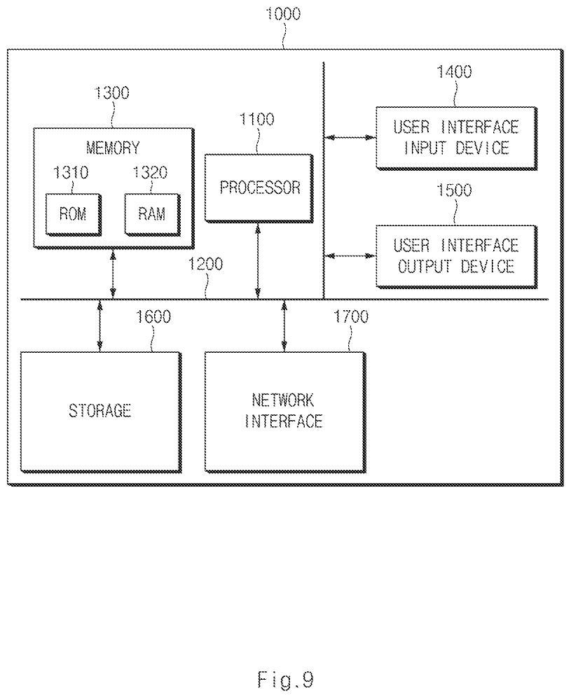

FIG. 9 illustrates a computing system according to various exemplary embodiments of the present invention.

Referring to FIG. 9, the computing system 1000 includes at least one processor 1100 connected through a bus 1200, a memory 1300, a user interface input device 1400, a user interface output device 1500, and a storage 1600, and a network interface 1700.

The processor 1100 may be a central processing unit (CPU) or a semiconductor device that performs processing on commands stored in the memory 1300 and/or the storage 1600. The memory 1300 and the storage 1600 may include various types of volatile or nonvolatile storage media. For example, the memory 1300 may include a read only memory (ROM) 1310 and a random access memory (RAM) 1320.

Accordingly, steps of a method or algorithm described in connection with the exemplary embodiments included herein may be directly implemented by hardware, a software module, or a combination of the two, executed by the processor 1100. The software module may reside in a storage medium (i.e., the memory 1300 and/or the storage 1600) such as a RAM memory, a flash memory, a ROM memory, an EPROM memory, a EEPROM memory, a register, a hard disk, a removable disk, and a CD-ROM.

An exemplary storage medium is coupled to the processor 1100, which can read information from and write information to the storage medium. Alternatively, the storage medium may be integrated with the processor 1100. The processor and the storage medium may reside within an application specific integrated circuit (ASIC). The ASIC may reside within a user terminal. Alternatively, the processor and the storage medium may reside as separate components within the user terminal.

The above description is merely illustrative of the technical idea of the present invention, and those skilled in the art to which various exemplary embodiments of the present invention pertains may make various modifications and variations without departing from the essential characteristics of the present invention.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

Furthermore, the term of “fixedly connected” signifies that fixedly connected members always rotate at a same speed. Furthermore, the term of “selectively connectable” signifies “selectively connectable members rotate separately when the selectively connectable members are not engaged to each other, rotate at a same speed when the selectively connectable members are engaged to each other, and are stationary when at least one of the selectively connectable members is a stationary member and remaining selectively connectable members are engaged to the stationary member”.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. An autonomous driving control apparatus comprising:
a processor configured to determine a wear degree of a tire of a vehicle according to image data of the tire during autonomous driving of the vehicle, and to perform vehicle control depending on the wear degree of the tire; and
a storage electrically connected to the processor and configured to store the image data and algorithms driven by the processor.

2. The autonomous driving control apparatus of claim 1, wherein the processor is configured to determine whether a steering angle of the vehicle is greater than a predetermined reference angle and a speed of the vehicle is lower than a predetermined reference speed.

3. The autonomous driving control apparatus of claim 2, wherein the processor is configured to set the predetermined reference angle at a predetermined ratio of a maximum value of an angle sensor of a motor driving power steering (MDPS) system.

4. The autonomous driving control apparatus of claim 1, wherein the processor is configured to normalize the image data when the tire is not worn, to store the normalized image data in the storage as a reference image in advance.

5. The autonomous driving control apparatus of claim 4, wherein the processor is configured to store the image data of the tire captured for each surrounding environmental condition in the storage as a reference image when the tire is not worn.

6. The autonomous driving control apparatus of claim 1, wherein the processor is configured to correct lens distortion of the image data obtained by capturing an image of the tire.

7. The autonomous driving control apparatus of claim 5, wherein the processor is configured to extract a region of interest (ROI) from the image data, and to normalize the image data.

8. The autonomous driving control apparatus of claim 7, wherein the processor is configured to determine image complexity according to a difference between the reference image and a currently acquired image of the tire to determine the wear degree of the tire.

9. The autonomous driving control apparatus of claim 7, wherein the processor is configured to extract a plurality of ROIs from the image data depending on a position of the tire, and the plurality of ROIs includes an external ROI, a central ROI, and an internal ROI.

10. The autonomous driving control apparatus of claim 9, wherein the processor is configured to determine the wear degree for each of the ROIs.

11. The autonomous driving control apparatus of claim 9, wherein the processor is configured to determine a pneumatic pressure state of the tire by use of the wear degree of the central ROI of the tire and the wear degrees of the external ROI and the internal ROI of the tire.

12. The autonomous driving control apparatus of claim 11, wherein the processor is configured to determine that a tire pressure is excessive when a value obtained by subtracting half of a sum of the wear degrees of the external ROI and the internal ROI from the wear degree of the central ROI of the tire is greater than or equal to a predetermined first threshold, and is configured to determine that the tire pressure is insufficient when the obtained value is lower than a predetermined second threshold.

13. The autonomous driving control apparatus of claim 9, wherein the processor is configured to determine a wheel balance of the tire by use of a difference between the wear degree of the external ROI of the tire and the wear degree of the internal ROI of the tire.

14. The autonomous driving control apparatus of claim 1, wherein the processor is configured to determine a risk state of the vehicle by determining a tire pressure state and a wheel balance of the vehicle according to the wear degree of the tire, and to subdivide the risk state in stages.

15. The autonomous driving control apparatus of claim 14,
wherein the risk state includes a warning level, and
wherein in the warning level, the processor is configured to perform a warning, and to control a braking force or a speed of the vehicle according to the wear degree of the tire.

16. The autonomous driving control apparatus of claim 1, wherein the processor is configured to determine the wear degree of front tires of the vehicle, and to estimate the wear degree of rear tires of the vehicle according to the wear degree of the front tires.

17. The autonomous driving control apparatus of claim 1, wherein the processor is configured to perform autonomous driving control of the vehicle according to the wear degree of the tire, a road surface condition, a driving score of a driver, and a driving distance of the vehicle.

18. A vehicle system comprising:
a camera configured to capture an image of a tire of a vehicle during the vehicle's autonomous driving; and
an autonomous driving control apparatus electrically connected to the camera and configured to determine a wear degree of the tire of the vehicle according to image data obtained by the camera capturing the image of the tire of the vehicle, and to perform vehicle control according to the wear degree of the tire.

19. An autonomous driving control method comprising:
capturing, by a sensing device, an image of a tire of a vehicle during the vehicle's autonomous driving;
determining, by a processor electrically connected to the sensing device, a wear degree of the tire according to image data of the tire obtained by the camera; and
performing, by the processor, vehicle control according to the wear degree of the tire.

20. The autonomous driving control method of claim 19, wherein the determining of the wear degree of the tire includes determining the wear degree of the tire according to a comparison between a reference image obtained by capturing an image of a tire which is not worn and a currently acquired image of the tire
